(19) United States
(12) Patent Application Publication
(10) Pub. No.: US 2007/0046859 A1
(43) Pub. Date: Mar. 1, 2007

(54) Backlight module with integrally molded metal back plate-frame and liquid crystal display using the same

(75) Inventors: Sin-Tung Huang, Miao-Li (TW); Ying-Chieh Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/510,884

(22) Filed: Aug. 28, 2006

(30) Foreign Application Priority Data
Aug. 26, 2005 (TW) 94129262

(51) Int. Cl. G02F 1/1335

(52) U.S. Cl. 349/65

(57) ABSTRACT

An exemplary backlight module (2) includes a metal back plate (21) and a frame (22) formed together as a single body, a light guide plate (24) having a light incident surface, and plural light sources (26) arranged adjacent to the light incident surface. The combined metal back plate and frame defines a space accommodating the light guide plate and the light sources. The combined metal back plate and frame can protect the light guide plate and the light sources from being displaced in the event of collision or shock. Therefore the backlight module can maintain reliable optical performance even in rugged application environments or when an accident occurs. A liquid crystal display using the backlight module is also provided.

### FIELD OF THE INVENTION

The present invention relates to backlight modules and liquid crystal displays (LCDs) using backlight modules; and particularly to a backlight module with an integrally molded back plate and frame, and an LCD using the backlight module.

### BACKGROUND

A typical LCD device includes a liquid crystal display panel, and a backlight module mounted under the liquid crystal display panel for supplying light beams thereto. Backlight modules can generally be classified into one of two types—direct types or edge types—according to the light source installation position in the backlight module's backlight unit.

Referring to FIG. 5, a typical edge type backlight module 1 includes a metal back plate 11, a frame 12, a reflective plate 13, a light guide plate 14, and a diffusion sheet 15. The metal back plate 11 includes an inner bottom surface 113, and a plurality of sides 111 with a plurality of holding holes 112. The frame 12 includes a plurality of sidewalls 121 with a plurality of catches 122 protruding outward from the sidewalls 121. The frame 12 is arranged on the inner bottom surface 113. The catches 122 engage in the holding holes 112, thereby fastening the metal back plate 11 to the frame 12. The combined metal back plate 11 and frame 12 accommodate the reflective plate 13, the light guide plate 14, and the diffusion sheet 15 in bottom-to-top order. A plurality of lamps 16 are arranged at one side of the light guide plate 14.

In the backlight module 1, the catches 122 and the holding holes 112 cooperate with each other to fasten the metal back plate 11 to the frame 12. However, if the backlight module 1 undergoes collision or shock, the catches 122 may become separated from the holding holes 112, and the frame 12 may thus become separated from the metal back plate 11. Furthermore, if the frame 12 becomes even slightly separated from the metal back plate 11, the reflective plate 13, the light guide plate 14, and the diffusion sheet 15 are liable to be displaced. This may in turn degrade the optical performance of the backlight module 1.

What is needed, therefore, is a backlight module which has a compact and robust structure. What is also needed is an LCD utilizing such a backlight module.

### SUMMARY

A backlight module includes a metal back plate and a frame formed together as a single body, a light guide plate having a light incident surface, and at least one light source arranged adjacent to the light incident surface. The combined metal back plate and frame defines a space accommodating the light guide plate and the at least one light source.

A liquid crystal display includes a display panel, and a backlight module positioned adjacent to the display panel. The backlight module includes a metal back plate and a frame formed together as a single body, a light guide plate having a light incident surface, and at least one light source arranged adjacent to the light incident surface. The combined metal back plate and frame defines a space accommodating the light guide plate and the at least one light source.

In the backlight module, the metal back plate and the frame are formed together as a single body, and thus the metal back plate and the frame are securely joined to each other. If the backlight module sustains collision or shock, the locations of the metal back plate and the frame remain unchanged relative to each other. Therefore, the light guide plate and the at least one light source are protected from displacement. Thus, unlike the above-described conventional backlight module, the backlight module including the integrally molded metal back plate and frame can maintain reliable optical performance even in rugged application environments or when an accident occurs. The liquid crystal display utilizing the backlight module has similar advantages.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present backlight module and liquid crystal display. Moreover, in the drawings, like reference numerals designate corresponding parts throughout the several views.

FIG. 1 is an exploded, isometric view of a backlight module according to a first preferred embodiment of the present invention.

FIG. 2 is a cross-sectional view taken along line II-II of FIG. 1.

FIG. 3 is an assembled view of the backlight module of FIG. 1.

FIG. 4 is an exploded, isometric view of a liquid crystal display according to a second preferred embodiment of the present invention, the liquid crystal display using the backlight module of FIG. 1.

FIG. 5 is an exploded, isometric view of a conventional backlight module.

### DETAILED DESCRIPTION OF PREFERRED EMBODIMENTS

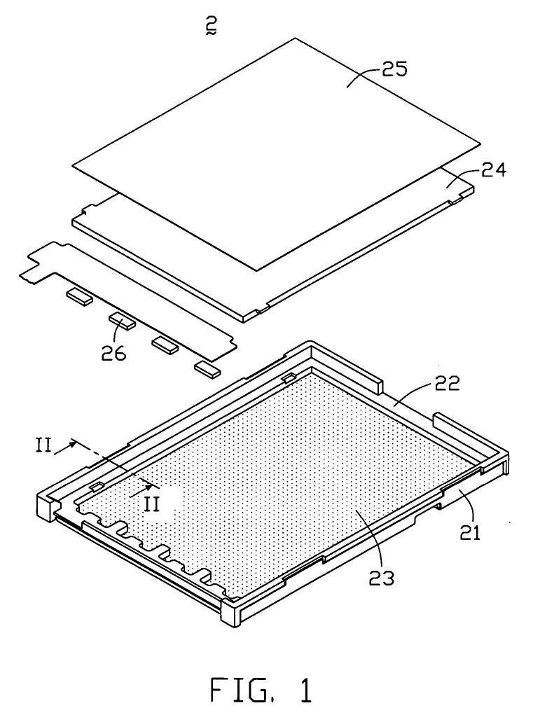

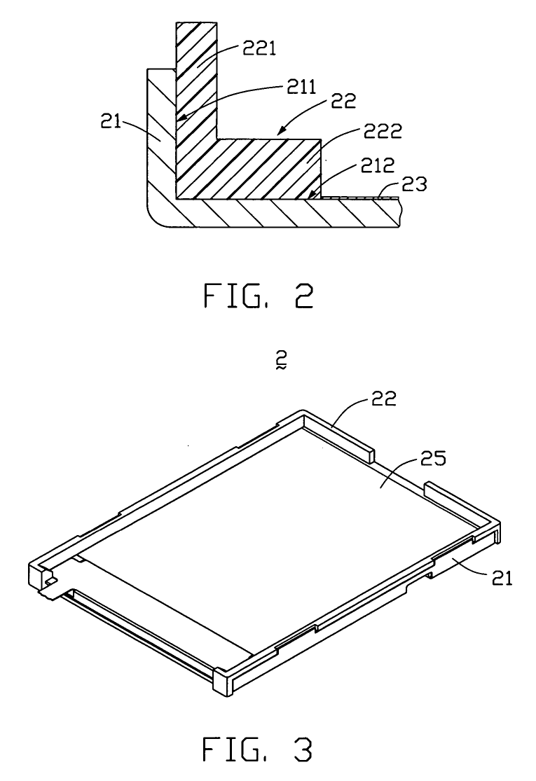

FIGS. 1 and 2 show a backlight module according to a first preferred embodiment of the present invention. The backlight module 2 includes an integrally molded metal back plate 21 and frame 22, a reflective element 23, a light guide plate 24, and a diffusion sheet 25. The metal back plate 21 and the frame 22 are integrally formed together as a single body, which defines a space for accommodating the reflective element 23, the light guide plate 24, and the diffusion sheet 25 in that order from bottom to top. The light guide plate 24 includes a light incident surface (not labeled) at a side edge thereof. A plurality of light sources 26 is arranged adjacent to the light incident surface. The metal back plate 21 may be made of aluminium. The frame 22 may be made of polycarbonate. The light sources 26 may be light emitting diodes (LEDs). The light guide plate 24 may be made of poly-methyl meth-acrylate (PMMA).

Referring to FIG. 2, the metal back plate 21 includes a pair of opposite inner side surfaces 211 (only one shown), and an inner bottom surface 212 between the inner side surfaces 211. The frame 22 is closely joined to the metal back plate 21 in a manner such that the frame 22 contacts the inner side surfaces 211 and the inner bottom surface 212. The frame 22 has a pair of opposite first sides 221 (only one shown) in contact with the inner side surfaces 211 respectively, and a pair of second sides 222 (only one shown) in contact with opposite lateral side portions of the inner bottom surface 212 respectively. Preferably, each of the first sides 221 is longer than the corresponding inner side surface 211, with opposite enlarged ends of the first side 221 abutting and surrounding opposite ends of the metal back plate 21 at the inner side surface 211. With this configuration, the metal back plate 21 is protected from deformation in the event of collision or shock. Each of the second sides 222 is much shorter than a corresponding width of the inner bottom surface 212, so that the reflective element 23 can be large-sized and located on a major portion of the inner bottom surface 212 between the second sides 222. The reflective element 23 can be a reflective sheet either substantially or almost completely covering the inner bottom surface 212. The reflective element 23 is made of reflective metallic material, such as silver or aluminium.

The metal back plate 21 and the frame 22 can be integrally molded together using an insert molding method. The insert molding method generally includes steps where an insert body is positioned in a mold, material forming a covering body is injected into the mold, and the insert body and the covering body are then fused together, whereby the material of the insert body and the material of the covering body are joined together to create a single integrally molded body. The insert body may be a metal body or a plastic body, and the covering body may be a plastic body.

FIG. 3 shows an assembled view of the backlight module 2. The reflective element 23, the light guide plate 24, the diffusion sheet 25, and the light sources 26 are positioned in the space of the combined metal back plate 21 and frame 22. In assembly of the backlight module 2, the reflective element 23 is arranged on the inner bottom surface 212 of the metal back plate 21. The light guide plate 24 is positioned on the reflective element 23, and the light sources 26 are arranged adjacent to the light incident surface of the light guide plate 24. The diffusion sheet 25 is positioned on the light guide plate 24. When the backlight module 2 is fully assembled and operating, light beams from the light sources 26 pass through the light guide plate 24 with or without reflection by the reflective element 23, exit a top surface of the light guide plate 24, and are evenly diffused by the diffusion sheet 25.

In summary, in the backlight module 2, the integrally formed metal back plate 21 and frame 22 are securely joined to each other. If the backlight module 2 sustains collision or shock, the locations of the metal back plate 21 and the frame 22 remain unchanged relative to each other. Therefore the reflective element 23, the light guide plate 24, the diffusion sheet 25, and the light sources 26 are protected from displacement. Thus unlike with the above-described conventional backlight module 1, the backlight module 2 can maintain reliable optical performance even in rugged application environments or when an accident occurs.

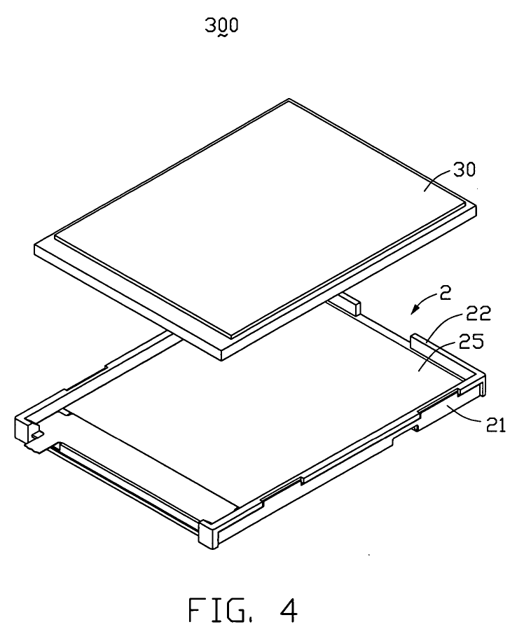

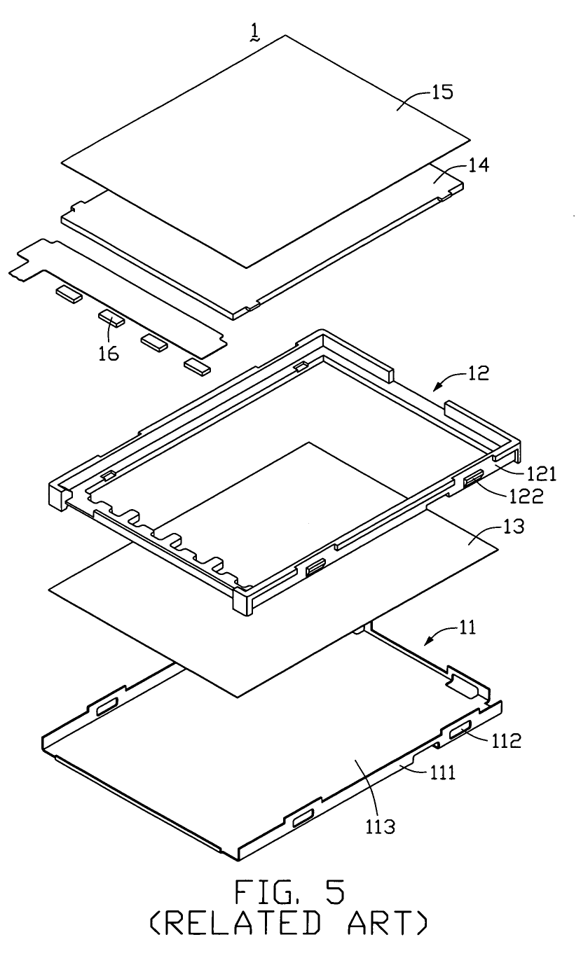

FIG. 4 shows a liquid crystal display using the backlight module 2. The liquid crystal display 300 includes a display panel 30, and the backlight module 2 positioned under the display panel 30. That is, the diffusion sheet 25 is positioned adjacent to the display panel 30. The backlight module 2 provides an even light source for illuminating the display panel 30. The backlight module 2 includes the integrally molded metal back plate 21 and frame 22, and therefore can maintain reliable optical performance even if subjected to collision or shock. Accordingly, the liquid crystal display 300 using the backlight module 2 can provide reliable optical performance even in rugged application environments or when an accident occurs.

The backlight module of the present invention is not limited to the embodiments described above. For example, in an alternative embodiment, the light sources 26 may be replaced by one or more cold cathode fluorescent lamps (CCFLs). In another alternative embodiment, the reflective element 23 may be a reflective layer formed on the inner bottom surface 212 by way of electroplating or sputtering.

It is to be further understood that even though numerous characteristics and advantages of various embodiments have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A backlight module, comprising:
a metal back plate and a frame formed together as a single body;
a light guide plate having a light incident surface; and
at least one light source arranged adjacent to the light incident surface;
wherein the combined metal back plate and frame defines a space accommodating the light guide plate and the at least one light source.

2. The backlight module as recited in claim 1, wherein the metal back plate and the frame are insert molded together.

3. The backlight module as recited in claim 1, further comprising a reflective element arranged between the frame and the light guide plate.

4. The backlight module as recited in claim 3, wherein the reflective element is made of reflective metallic material.

5. The backlight module as recited in claim 3, wherein the reflective element is a reflective sheet, or a reflective layer formed directly on the metal back plate.

6. The backlight module as recited in claim 1, wherein the metal back plate is made of aluminium.

7. The backlight module as recited in claim 1, wherein the frame is made of polycarbonate.

8. A liquid crystal display, comprising:
a display panel; and
a backlight module positioned adjacent to the display panel, the backlight module comprising:
a metal back plate and a frame formed together as a single body;
a light guide plate having a light incident surface; and
at least one light source arranged adjacent to the light incident surface;
wherein the combined metal back plate and frame defines a space accommodating the light guide plate and the at least one light source.

9. The liquid crystal display as recited in claim 8, wherein the metal back plate and the frame are insert molded together.

10. The liquid crystal display as recited in claim 8, further comprising a reflective element arranged between the frame and the light guide plate.

11. The liquid crystal display as recited in claim 10, wherein the reflective element is made of reflective metallic material.

12. The liquid crystal display as recited in claim 10, wherein the reflective element is a reflective sheet, or a reflective layer formed directly on the metal back plate.

13. The liquid crystal display as recited in claim 8, wherein the metal back plate is made of aluminium.

14. The liquid crystal display as recited in claim 8, wherein the frame is made of polycarbonate.

15. A backlight module, comprising:
a metal back plate and a frame integrally formed together as a single body;
a light guide plate having a light incident surface; and
at least one light source arranged adjacent to the light incident surface;
wherein a bottom of the frame is directly seated upon a top face of the metal back plate.

16. The backlight module as claimed in claim 15, wherein the combined metal back plate and frame defines a space accommodating the light guide plate and the at least one light source.
